(19) United States
(12) Patent Application Publication
(10) Pub. No.: US 2023/0080554 A1
(43) Pub. Date: Mar. 16, 2023

(54) INFORMATION DISPLAY DEVICE

(71) Applicant: BEIJING BAIDU NETCOM SCIENCE TECHNOLOGY CO., LTD., BEIJING (CN)

(72) Inventor: Xingyue JIANG, BEIJING (CN)

(21) Appl. No.: 17/990,540

(22) Filed: Nov. 18, 2022

Related U.S. Application Data
(63) Continuation of application No. PCT/CN2022/085324, filed on Apr. 6, 2022.

(30) Foreign Application Priority Data
Sep. 17, 2021 (CN) 202111092283.3

(51) Int. Cl. H04L 9/40; G06K 7/14; G06K 7/10

(52) U.S. Cl. CPC H04L 63/0861; G06K 7/1417; G06K 7/10722

(57) ABSTRACT

A display device is provided. The present disclosure relates to the field of artificial intelligence technologies, and in particular, to the fields of big data and smart device technologies. An implementation solution includes: a device body, wherein a display screen and a first input control are disposed on the device body; and a controller electrically connected to the first input control and the display screen, where the controller is configured to: based on receiving a first information request instruction input through the first input control and determining that the display device has been associated with a first preset application, obtain first information to be displayed for the first information request instruction, and control the display screen to display the first information to be displayed.

### CROSS-REFERENCE TO RELATED APPLICATIONS

The present application is a continuation of International Application No. PCT/CN2022/085324, filed on Apr. 6, 2022, which claims priority to Chinese Patent Application No. 202111092283.3, filed on Sep. 17, 2021. Both of the aforementioned applications are hereby incorporated by reference in their entireties for all purposes.

### TECHNICAL FIELD

The present disclosure relates to the field of artificial intelligence technologies, and in particular, to the fields of big data and smart device technologies, and specifically to an information display device.

### BACKGROUND

In modern society, information is updated rapidly, and it is necessary to show related information on some occasions before passing. For example, for the sake of public health, people often need to obtain information such as health codes and travel cards at any time by using smart devices such as mobile phones, and show such information to pass when entering public places such as subways and shopping malls.

The methods described in this section are not necessarily methods that have been previously conceived or employed. It should not be assumed that any of the methods described in this section is considered to be the related art just because they are included in this section, unless otherwise indicated expressly. Similarly, the problem mentioned in this section should not be considered to be universally recognized in any related art, unless otherwise indicated expressly.

### SUMMARY

The present disclosure provides an information display device.

According to an aspect of the present disclosure, there is provided a display device, including: a device body, wherein a display screen and a first input control are disposed on the device body; and a controller electrically connected to the first input control and the display screen, where the controller is configured to: based on receiving a first information request instruction input through the first input control and determining that the display device has been associated with a first preset application, obtain first information to be displayed for the first information request instruction, and control the display screen to display the first information to be displayed, where the first information request is input through the first preset application.

According to one or more embodiments of the present disclosure, the information display device can be associated with an application, and a request instruction related to the application may be directly input through an input control disposed on the display device to obtain and display information to be displayed, so that complex steps such as opening the application are omitted, the operation is simple and convenient, the requirement of a user for presenting information conveniently at any time can be met, and the efficiency is improved.

It should be understood that the content described in this section is not intended to identify critical or important features of the embodiments of the present disclosure, and is not used to limit the scope of the present disclosure either. Other features of the present disclosure will be easily understood through the following description.

### BRIEF DESCRIPTION OF THE DRAWINGS

The accompanying drawings in some embodiments show embodiments and form a part of the specification, and are used to explain example implementations of the embodiments together with a written description of the specification. The embodiments shown are merely for illustrative purposes and do not limit the scope of the claims. Throughout the accompanying drawings, the same reference numerals denote similar but not necessarily same elements.

FIG. 1 is a schematic diagram of an example system in which various methods described herein can be implemented according to an embodiment of the present disclosure;

FIG. 2A is a front view of a display device 200 according to an embodiment of the present disclosure;

FIG. 2B is a rear view of a display device 200 according to an embodiment of the present disclosure;

FIG. 2C is a block diagram of a partial structure of a display device 200 according to an embodiment of the present disclosure;

FIG. 3 is a flowchart of a method 300 for associating a display device with a first preset application according to an embodiment of the present disclosure;

FIG. 4 is a schematic diagram of a use process of an information display device according to an embodiment of the present disclosure; and

FIG. 5 is a structural block diagram of an example electronic device 400 that can be used to implement an embodiment of the present disclosure.

### DETAILED DESCRIPTION OF EMBODIMENTS

Example embodiments of the present disclosure are described below with reference to the accompanying drawings, where various details of the embodiments of the present disclosure are included for a better understanding, and should be considered as merely example. Therefore, those of ordinary skill in the art should be aware that various changes and modifications can be made to the embodiments described herein, without departing from the scope of the present disclosure. Likewise, for clarity and conciseness, the description of well-known functions and structures is omitted in the following description.

In the present disclosure, unless otherwise stated, the terms “first”, “second”, etc., used to describe various elements are not intended to limit the positional, temporal or importance relationship of these elements, but rather only to distinguish one component from another. In some examples, the first element and the second element may refer to the same instance of the element, and in some cases, based on contextual descriptions, they may also refer to different instances.

The terms used in the description of the various examples in the present disclosure are merely for the purpose of describing particular examples, and are not intended to be limiting. If the number of elements is not specifically defined, there may be one or more elements, unless otherwise expressly indicated in the context. Moreover, the term “and/or” used in the present disclosure encompasses any of and all possible combinations of listed items.

The embodiments of the present disclosure will be described below in detail with reference to the accompanying drawings.

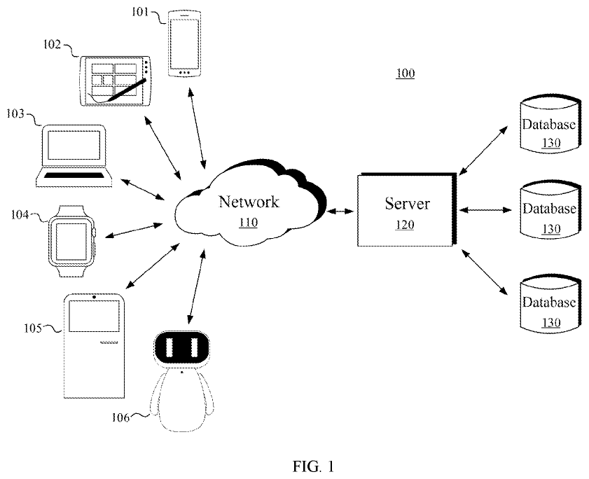

FIG. 1 is a schematic diagram of an example system 100 in which various methods and apparatuses described herein can be implemented according to an embodiment of the present disclosure. Referring to FIG. 1, the system 100 includes one or more display devices 101, 102, 103, 104, 105, and 106, a server 120, and one or more communications networks 110 that couple the one or more display devices to the server 120. The display devices 101, 102, 103, 104, 105, and 106 may be configured to execute one or more applications.

In an embodiment of the present disclosure, the server 120 can run one or more services or software applications that enable a method for receiving an information request and sending information to be displayed, and receiving a face image and sending an authentication result for the face image to the display device, and a method for receiving position information from the display device to be performed.

In some embodiments, the server 120 may further provide other services or software applications that may include a non-virtual environment and a virtual environment. In some embodiments, these services may be provided as web-based services or cloud services, for example, provided to a user of the display device 101, 102, 103, 104, 105, and/or 106 in a software as a service (SaaS) model.

In the configuration shown in FIG. 1, the server 120 may include one or more components that implement functions performed by the server 120. These components may include software components, hardware components, or a combination thereof that can be executed by one or more processors. A user operating the display device 101, 102, 103, 104, 105, and/or 106 may sequentially use one or more client applications to interact with the server 120, thereby utilizing the services provided by these components. It should be understood that various system configurations are possible, which may be different from the system 100. Therefore, FIG. 1 is an example of the system for implementing various methods described herein, and is not intended to be limiting.

The user may use the display device 101, 102, 103, 104, 105, and/or 106 to receive and display related information. The display device may provide an interface that enables the user of the display device to interact with the display device. The display device may also output information to the user via the interface. Although FIG. 1 depicts only six types of display devices, those skilled in the art will understand that any number of display devices are possible in the present disclosure.

The display device 101, 102, 103, 104, 105, and/or 106 may include various types of computer devices, such as a portable handheld device, a general-purpose computer (such as a personal computer and a laptop computer), a workstation computer, a wearable device, a smart screen device, a self-service terminal device, a service robot, a gaming system, a thin client, various messaging devices, and a sensor or other sensing devices. These computer devices can run various types and versions of software applications and operating systems, such as MICROSOFT Windows, APPLE iOS, a UNIX-like operating system, and a Linux or Linux-like operating system (e.g., GOOGLE Chrome OS); or include various mobile operating systems, such as MICROSOFT Windows Mobile OS, iOS, Windows Phone, and Android. The portable handheld device may include a cellular phone, a smartphone, a tablet computer, a personal digital assistant (PDA), etc. The wearable device may include a head-mounted display (such as smart glasses) and other devices. The gaming system may include various handheld gaming devices, Internet-enabled gaming devices, etc. The display device can execute various applications, such as various Internet-related applications, communication applications (e.g., email applications), and short message service (SMS) applications, and can use various communication protocols.

The network 110 may be any type of network well known to those skilled in the art, and it may use any one of a plurality of available protocols (including but not limited to TCP/IP, SNA, IPX, etc.) to support data communication. As a mere example, the one or more networks 110 may be a local area network (LAN), an Ethernet-based network, a token ring, a wide area network (WAN), the Internet, a virtual network, a virtual private network (VPN), an intranet, an extranet, a public switched telephone network (PSTN), an infrared network, a wireless network (such as Bluetooth or Wi-Fi), and/or any combination of these and/or other networks.

The server 120 may include one or more general-purpose computers, a dedicated server computer (e.g., a personal computer (PC) server, a UNIX server, or a terminal server), a blade server, a mainframe computer, a server cluster, or any other suitable arrangement and/or combination. The server 120 may include one or more virtual machines running a virtual operating system, or other computing architectures relating to virtualization (e.g., one or more flexible pools of logical storage devices that can be virtualized to maintain virtual storage devices of a server). In various embodiments, the server 120 can run one or more services or software applications that provide functions described below.

A computing unit in the server 120 can run one or more operating systems including any of the above operating systems and any commercially available server operating system. The server 120 can also run any one of various additional server applications and/or middle-tier applications, including an HTTP server, an FTP server, a CGI server, a JAVA server, a database server, etc.

In some implementations, the server 120 may include one or more applications to analyze and merge data feeds and/or event updates received from users of the display device 101, 102, 103, 104, 105, and 106. The server 120 may further include one or more applications to display the data feeds and/or real-time events via one or more display devices of the display device 101, 102, 103, 104, 105, and 106.

In some implementations, the server 120 may be a server in a distributed system, or a server combined with a blockchain. The server 120 may alternatively be a cloud server, or an intelligent cloud computing server or intelligent cloud host with artificial intelligence technologies. The cloud server is a host product in a cloud computing service system, to overcome the shortcomings of difficult management and weak service scalability in conventional physical host and virtual private server (VPS) services.

The system 100 may further include one or more databases 130. In some embodiments, these databases can be used to store data and other information. For example, one or more of the databases 130 can be used to store information such as an audio file and a video file. The databases 130 may reside in various locations. For example, a database used by the server 120 may be locally in the server 120, or may be remote from the server 120 and may communicate with the server 120 via a network-based or dedicated connection. The databases 130 may be of different types. In some embodiments, the database used by the server 120 may be, for example, a relational database. One or more of these databases can store, update, and retrieve data from or to the database, in response to a command.

In some embodiments, one or more of the databases 130 may also be used by an application to store application data. The database used by the application may be of different types, for example, may be a key-value repository, an object repository, or a regular repository backed by a file system.

The system 100 of FIG. 1 may be configured and operated in various manners, such that the various methods and apparatuses described according to the present disclosure can be applied.

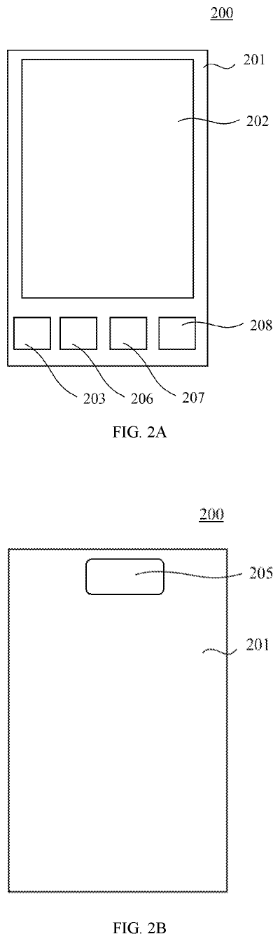

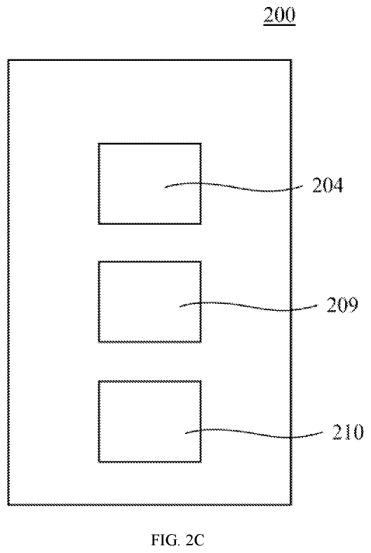

FIG. 2A is a front view of a display device 200 according to an embodiment of the present disclosure; FIG. 2B is a rear view of a display device 200 according to an embodiment of the present disclosure; and FIG. 2C is a block diagram of a partial structure of a display device 200 according to an embodiment of the present disclosure.

As shown in FIG. 2A, FIG. 2B, and FIG. 2C, the display device 200 includes: a device body 201, a display screen 202, a first input control 203, and a control unit 204. The display screen 202 and the first input control 203 are disposed on the device body 201. The control unit 204 is electrically connected to the first input control 203 and the display screen 202, and the control unit 204 is configured for: in response to receiving a first information request instruction input through the first input control 203 and determining that the information display device 200 has been associated with a first preset application, obtaining first information to be displayed for the first information request instruction, and controlling the display screen 202 to display the first information to be displayed, where the first information request can be input through the first preset application. Therefore, the display device 200 may receive an instruction from a user through the first input control 203, to obtain information to be displayed in the first preset application, and display the information to be displayed on the display screen 202 without another operation, which is convenient and fast. When the user needs to present the information to be displayed frequently, using the display device 200 to present the information may improve efficiency.

In some embodiments, the first input control 203 may be a physical key, and the user may input the first information request instruction by pressing the physical key. It can be understood that the first input control may alternatively be another control, for example, a roller or a rocking bar.

In some other embodiments, the first input control 203 may alternatively be a virtual control on the display screen, and the user may trigger the virtual control by clicking, sliding or long pressing on the display screen, so as to input the first information request instruction.

According to some embodiments of the present disclosure, the device body 201 has a card-shaped structure. Therefore, since the display device 200 having the card-shaped structure is convenient to carry, the user may carry the display device 200 to present at any time the first information to be displayed.

According to some embodiments of the present disclosure, the first information to be displayed is a health code, and an operation on the first input control may enable the display device 200 to display the health code.

In some embodiments, for the sake of public health, in many public places, such as subway and shopping malls, the health code of the user needs to be verified as a green code before the user is allowed to pass. At many times, the user carries an electronic device such as a mobile phone, and the health code may be displayed only after a series of operations in an application. It may bring great inconvenience to an unskilled user such as the elderly. At the same time, a user who is restricted to use such electronic device, such as a child, is often unable to present the health code when traveling alone. Moreover, for a person who needs frequent access to public places, such as a takeout deliverer, complex operations may waste a lot of time and be extremely inconvenient. Since the first information to be displayed of the display device 200 may be the health code, the user may carry the display device 200, and may enable the display screen 202 to display the health code only by operating the first input control 203, such that the above problem is well solved, and it is convenient for specific people to travel.

According to some embodiments of the present disclosure, the information display device 200 may communicate with an external device through, but not limited to an Internet of Things card, to send information to and receive information sent from the external device.

According to some embodiments of the present disclosure, the display device 200 further includes: a camera 205 and a second input control 206 disposed on the device body 201, where the control unit 204 is electrically connected to the camera 205 and the second input control 206, and the control unit 204 is further configured for: in response to receiving a code scanning instruction input through the second input control 206 and determining that the display device 200 has been associated with the first preset application, controlling the camera 205 to be turned on to scan a target two-dimensional bar code, such that an associated device corresponding to the target two-dimensional bar code can obtain related information to the display device 200 through the target two-dimensional bar code. Therefore, the display device 200 may receive an instruction from the user through the second input control 206 to scan the two-dimensional bar code and log in information in the display device 200 in an associated device corresponding to the two-dimensional bar code.

In some examples, the target two-dimensional bar code may be a place code. For the sake of public health, in order to track personal travel information of the user, the place code may be set in a public place such as a transportation means. In some examples, for example, when a user who takes a transportation means A is required to scan a place code of the transportation means A to log in personal information, the user may input the code scanning instruction in the display device 200 by operating the second input control 206 of the display device 200. When the display device 200 has been associated with the first preset application, the camera 205 is controlled to be turned on and scan the place code of the transportation means A, such that an associated device of the place code obtains related information in the display device 200, that is, the personal information of the user in the display device 200 may be sent to the associated device of the place code to register the personal information of the user. When there is an emergency on the transportation means A, a manager may track the user based on all the personal information of the user collected in the associated device.

According to some embodiments of the present disclosure, the control unit 204 is further configured for: in response to receiving the code scanning instruction input through the second input control 206 and determining that the display device 200 has been associated with the first preset application, obtaining the first information to be displayed, and controlling the display screen 202 to display the first information to be displayed. Therefore, when scanning a code, the display device 200 may also display the information to be displayed, further improving the travel efficiency of the user.

In some examples, the first information to be displayed may be the health code. While the user operates the second input control to scan the place code and register the personal information, it may be further achieved that the display screen 202 of the display device 200 displays the health code, which is convenient for the user to perform the operations simultaneously.

According to some embodiments of the present disclosure, the display device 200 further includes: a third input control 207 disposed on the device body 201, where the control unit 204 is electrically connected to the third input control 207, and the control unit 204 is further configured for: in response to receiving a second information request instruction input through the third input control 207 and determining that the display device 200 has been associated with a second preset application, obtaining second information to be displayed for the second information request instruction, and controlling the display screen 202 to display the second information to be displayed, where the second information request can be input through the second preset application. Therefore, the display device 200 may receive an instruction from a user through the third input control 207, to obtain the second information to be displayed and display the second information to be displayed on the display screen 202 without another operation, which is convenient and fast. When the user needs to frequently present two types of information to be displayed, the first input control 203 and the third input control 207 may be controlled respectively to present different information. According to some embodiments of the present disclosure, the second information to be displayed is a travel card.

In some examples, in a case that the second information to be displayed is a travel card, the second preset application may be an applet, and the applet may be pre-bound to a passage big data travel card. The user controls the third input control 207 on the display device 200, such that the display device 200 may obtain travel card information of the user through the second preset application and display the travel card information of the user on the display screen.

According to some embodiments of the present disclosure, the first input control 203 and the third input control 207 are the same control, and the first information request instruction and the second information request instruction are respectively input by an operation on the first input control 203. Therefore, by performing the same or different operations on one input control, the user can make the display device 200 display different information to be displayed, which simplifies the structure of the display device 200 and facilitates the operation of the user.

In some examples, the first input control 203 and the third input control 207 may be the same physical key. When the user presses the physical key once, the display device 200 is triggered to display the first information to be displayed; and when the user presses the physical key again, the display device 200 is triggered to display the second information to be displayed.

In some examples, the first input control 203 and the third input control 207 may be the same touchscreen. When the user slides from left to right on the touchscreen, the display device 200 displays the first information to be displayed; and when the user slides from right to left on the touchscreen, the display device 200 displays the second information to be displayed.

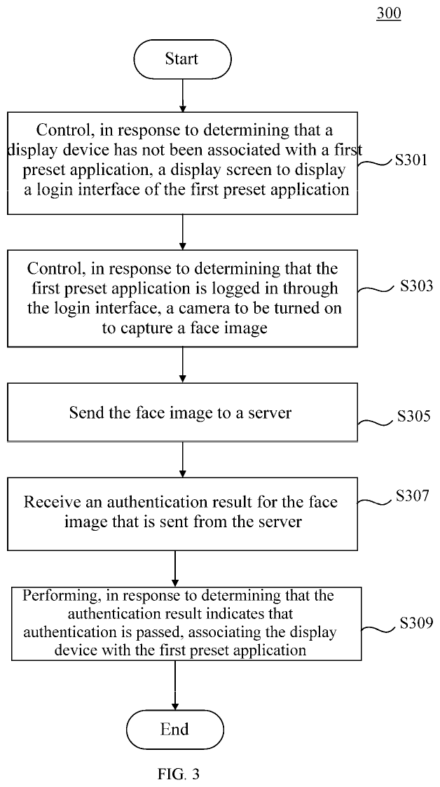

FIG. 3 is a flowchart of a method 300 for associating a display device 200 with a first preset application according to an embodiment of the present disclosure.

According to some embodiments of the present disclosure, as shown in FIG. 3, when the display device 200 includes a camera 205, the control unit 204 is configured for associating the display device 200 with the first preset application through the following steps: step S301: controlling, in response to determining that the display device 200 has not been associated with the first preset application, the display screen 202 to display a login interface of the first preset application; step S303: controlling, in response to determining that the first preset application has been logged in through the login interface, the camera 205 to be turned on to capture a face image; step S305: sending the face image to a server; step S307: receiving an authentication result for the face image that is sent from the server; and step S309: performing, in response to determining that the authentication result indicates that authentication is passed, associating the display device 200 with the first preset application. According to the method 300, the first preset application may be pre-installed on the display device, and the association between the display device and the first preset application may be implemented by logging in the first preset application. After the association, a request instruction related to the first preset application may be input by operating the first input control to obtain and display information to be displayed. Therefore, after the association, complex steps such as opening the application every time are omitted, the operation is simple and convenient, requirements of a user for presenting information conveniently at any time can be met, and the efficiency is improved. It can be understood that the steps of face authentication in steps S303 to S307 may alternatively be omitted in the solution.

According to some other embodiments of the present disclosure, when the display device 200 includes the camera 205, the control unit 204 is configured for associating the display device 200 with the first preset application through the following step: controlling the camera 205 to be turned on to scan a first two-dimensional bar code corresponding to a first preset application logged in on another terminal device, such that the display device 200 is associated with the first preset application through the first two-dimensional bar code. Therefore, the user may use the display device 200 to scan the first two-dimensional bar code on the terminal device to associate the display device with first preset application on the terminal device, and achieve the association between the display device and the first preset application.

In some examples, the terminal device may be a mobile phone, a tablet computer, or the like. The display device 200 may scan the first two-dimensional bar code on the terminal device through the above operation, so as to obtain user account information input by the user in the first preset application of the terminal device to implement login.

According to some other embodiments of the present disclosure, when the display device 200 includes the camera 205, the control unit 204 is configured for associating the display device 200 with the first preset application through the following step: controlling the display screen 202 to display a second two-dimensional bar code corresponding to the display device 200, such that the association of the display device 200 with the first preset application can be implemented by scanning the second two-dimensional bar code through the first preset application logged in on the another terminal device. Therefore, the display device 200 is associated with the first preset application by using the terminal device to scan the second two-dimensional bar code on the display device 200, thereby implementing the association between the display device and the first preset application.

In some examples, the terminal device may be a mobile phone, a tablet computer, or the like. Through the above operation, the second two-dimensional bar code on the display device 200 may be scanned through the first preset application logged in on the terminal device, so as to obtain the user account information input by the user on the terminal device, implementing the association.

In some examples, information association may be implemented after the display device 200 obtains personal information of the user, to obtain information such as a health code and travel card of the user, and obtain the personal information of the user that needs to be registered when scanning a place code.

It can be understood that a manner of associating the display device 200 with the second preset application is similar to a manner of associating the display device 200 with the first preset application, and details are not described herein again.

According to some embodiments of the present disclosure, the display device 200 further includes: a fourth input control 208 and a near field communications unit 209 disposed on the device body 201, where the control unit 204 is electrically connected to the fourth input control 208 and the near field communications unit 209, and the control unit 204 is further configured for: in response to receiving a connection instruction input through the fourth input control 208, obtaining data of a smart device in contact with the display device 200 through the near field communications unit 209, such that the display device 200 is associated with the smart device. Therefore, the display device 200 may receive the connection instruction through the fourth input control 208 and the near field communications unit 209, to be associated with another smart device, which enriches functions of the display device, and improves the universality.

According to some embodiments of the present disclosure, the smart device includes a traffic card and/or an entrance guard card. The display device 200 may be associated with the traffic card and/or the entrance guard card.

In some examples, the near field communications unit 209 may be an NFC unit. The user may trigger the fourth input control 208 to cause the NFC unit to obtain data in the traffic card and the entrance guard card, to associate the display device 200 with the traffic card and the entrance guard card. When the traffic card requires to be used for payment, the display device 200 associated with information of the traffic card may be used for payment by card; and when the entrance guard card requires to be used to open a door, the display device 200 associated with information of the entrance guard card may be used to open the door by card.

According to some embodiments of the present disclosure, the display device 200 further includes: a positioning unit 210 disposed on the device body 201 and configured for obtaining position information of the display device 200, where the control unit 204 is electrically connected to the positioning unit 210, and the control unit 204 is further configured for sending the position information obtained by the positioning unit 210 to the server.

In some examples, the positioning unit 210 may be a GPS positioning system, and may obtain the position information of the display device 200, that is, travel information of the user. Furthermore, the control unit 204 may further send the position information obtained by the positioning unit 210 to the server, to dynamically update travel information of the user in the server.

In some embodiments of the present disclosure, the structures and triggering manners of the second input control 206, the third input control 207, and the fourth input control 208 are the same as or similar to those of the first input control 203, and details are not described herein again.

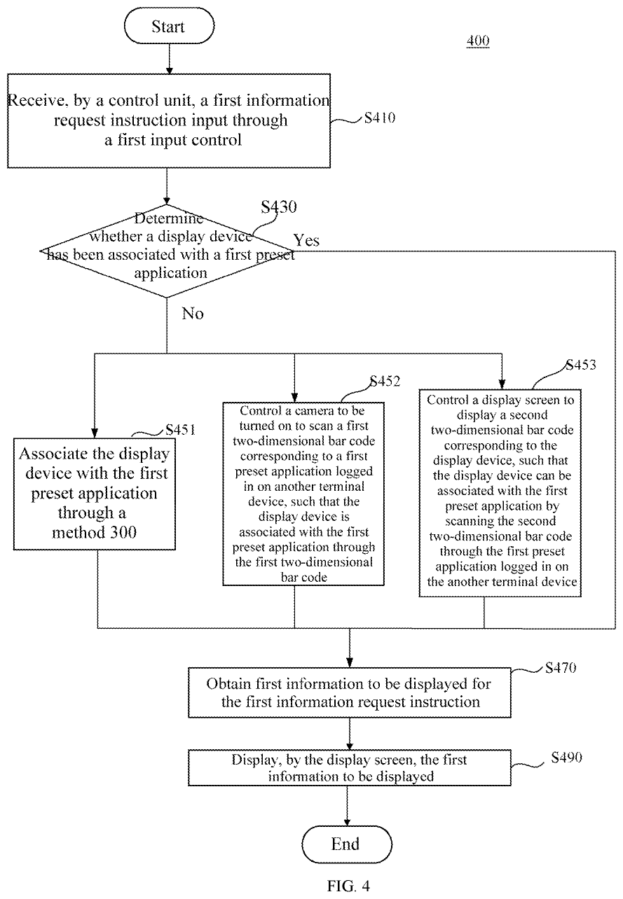

As shown in FIG. 4, according to some embodiments, a use process of the information display device in the present disclosure may be as follows: step S410: receiving, by a control unit, a first information request instruction input through a first input control; step S430: determining whether the display device has been associated with a first preset application, and if the display device has not been associated with the first preset application, performing step S451, step S452 or step S453 to associate the display device with the first preset application; and if the display device has been associated with the first preset application, performing step S470 and step S490 to display first information to be displayed.

Specifically, the steps of associating the display device with the first preset application optionally include: step S451: associating the display device with the first preset application through the method 300; step S452: controlling a camera to be turned on to scan a first two-dimensional bar code corresponding to a first preset application logged in on another terminal device, such that the display device is associated with the first preset application through the first two-dimensional bar code; and step S453: controlling a display screen to display a second two-dimensional bar code corresponding to the display device, such that the association of the display device with the first preset application can be implemented by scanning the second two-dimensional bar code through the first preset application logged in on the another terminal device;

After the display device is associated with the first preset application, performing step S470: obtaining the first information to be displayed for the first information request instruction; and step S490: displaying, by the display screen, the first information to be displayed. A process of displaying second information to be displayed is similar to the process of displaying the first information to be displayed, and details are not described herein again.

In the technical solutions of the present disclosure, collection, storage, use, processing, transmission, provision, disclosure, etc. of user personal information involved all comply with related laws and regulations and are not against the public order and good morals.

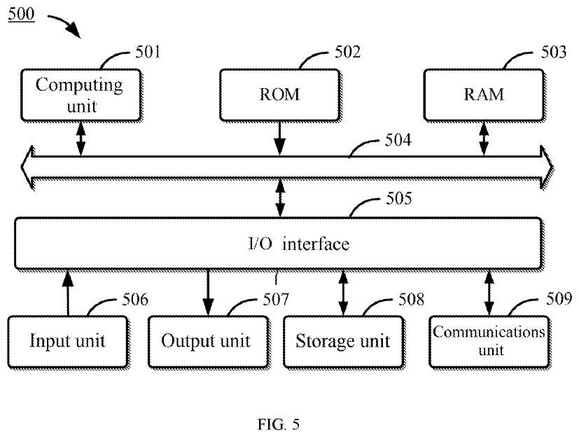

Referring to FIG. 5, a structural block diagram of an electronic device 500 that can serve as a server or a client of the present disclosure is now described, which is an example of a hardware device that can be applied to various aspects of the present disclosure. The electronic device is intended to represent various forms of digital electronic computer devices, such as a laptop computer, a desktop computer, a workstation, a personal digital assistant, a server, a blade server, a mainframe computer, and other suitable computers. The electronic device may also represent various forms of mobile apparatuses, such as a personal digital assistant, a cellular phone, a smartphone, a wearable device, and other similar computing apparatuses. The components shown herein, their connections and relationships, and their functions are merely examples, and are not intended to limit the implementation of the present disclosure described and/or required herein.

As shown in FIG. 5, the device 500 includes a computing unit 501, which may perform various appropriate actions and processing according to a computer program stored in a read-only memory (ROM) 502 or a computer program loaded from a storage unit 508 to a random access memory (RAM) 503. The RAM 503 may further store various programs and data required for the operation of the device 500. The computing unit 501, the ROM 502, and the RAM 503 are connected to each other through a bus 504. An input/output (I/O) interface 505 is also connected to the bus 504.

A plurality of components in the device 500 are connected to the I/O interface 505, including: an input unit 506, an output unit 507, the storage unit 508, and a communication unit 509. The input unit 506 may be any type of device capable of entering information to the device 500. The input unit 506 can receive entered digit or character information, and generate a key signal input related to user settings and/or function control of the electronic device, and may include, but is not limited to, a mouse, a keyboard, a touchscreen, a trackpad, a trackball, a joystick, a microphone, and/or a remote controller. The output unit 507 may be any type of device capable of presenting information, and may include, but is not limited to, a display, a speaker, a video/audio output terminal, a vibrator, and/or a printer. The storage unit 508 may include, but is not limited to, a magnetic disk and an optical disc. The communications unit 509 allows the device 500 to exchange information/data with other devices via a computer network such as the Internet and/or various telecommunications networks, and may include, but is not limited to, a modem, a network interface card, an infrared communication device, a wireless communication transceiver and/or a chipset, e.g., a Bluetooth™ device, a 1302.11 device, a Wi-Fi device, a WiMAX device, a cellular communication device, and/or the like.

The computing unit 501 may be various general-purpose and/or special-purpose processing components with processing and computing capabilities. Some examples of the computing unit 501 include, but are not limited to, a central processing unit (CPU), a graphics processing unit (GPU), various dedicated artificial intelligence (AI) computing chips, various computing units that run machine learning model algorithms, a digital signal processor (DSP), and any appropriate processor, controller, microcontroller, etc. The computing unit 501 performs the various methods and processing described above, for example, the method 300. For example, in some embodiments, the method 300 may be implemented as a computer software program, which is tangibly contained in a machine-readable medium, such as the storage unit 508. In some embodiments, a part or all of the computer program may be loaded and/or installed onto the device 500 via the ROM 502 and/or the communications unit 509. When the computer program is loaded onto the RAM 503 and executed by the computing unit 501, one or more steps of the method 300 described above can be performed. Alternatively, in other embodiments, the computing unit 501 may be configured, by any other suitable means (for example, by means of firmware), to perform the method 300.

Various implementations of the systems and technologies described herein above can be implemented in a digital electronic circuit system, an integrated circuit system, a field programmable gate array (FPGA), an application-specific integrated circuit (ASIC), an application-specific standard product (ASSP), a system-on-chip (SOC) system, a complex programmable logical device (CPLD), computer hardware, firmware, software, and/or a combination thereof. These various implementations may include: they are implemented in one or more computer programs, where the one or more computer programs may be executed and/or interpreted on a programmable system including at least one programmable processor. The programmable processor may be a dedicated or general-purpose programmable processor that can receive data and instructions from a storage system, at least one input apparatus, and at least one output apparatus, and transmit data and instructions to the storage system, the at least one input apparatus, and the at least one output apparatus.

Program codes used to implement the method of the present disclosure can be written in any combination of one or more programming languages. These program codes may be provided for a processor or a controller of a general-purpose computer, a special-purpose computer, or other programmable data processing apparatuses, such that the program codes, when being executed by the processor or the controller, enable the functions/operations specified in the flowcharts and/or block diagrams to be implemented. The program codes may be completely executed on a machine, or partially executed on a machine, or may be, as an independent software package, partially executed on a machine and partially executed on a remote machine, or completely executed on a remote machine or a server.

In the context of the present disclosure, the machine-readable medium may be a tangible medium, which may contain or store a program for use by an instruction execution system, apparatus, or device, or for use in combination with the instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of the machine-readable storage medium may include an electrical connection based on one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof

In order to provide interaction with a user, the systems and technologies described herein can be implemented on a computer which has: a display apparatus (for example, a cathode-ray tube (CRT) or a liquid crystal display (LCD) monitor) for displaying information to the user; and a keyboard and a pointing apparatus (for example, a mouse or a trackball) through which the user can provide an input to the computer. Other types of apparatuses can also be used to provide interaction with the user; for example, feedback provided to the user can be any form of sensory feedback (for example, visual feedback, auditory feedback, or tactile feedback), and an input from the user can be received in any form (including an acoustic input, a voice input, or a tactile input).

The systems and technologies described herein can be implemented in a computing system (for example, as a data server) including a backend component, or a computing system (for example, an application server) including a middleware component, or a computing system (for example, a user computer with a graphical user interface or a web browser through which the user can interact with the implementation of the systems and technologies described herein) including a frontend component, or a computing system including any combination of the backend component, the middleware component, or the frontend component. The components of the system can be connected to each other through digital data communication (for example, a communications network) in any form or medium. Examples of the communications network include: a local area network (LAN), a wide area network (WAN), and the Internet.

A computer system may include a client and a server. The client and the server are generally far away from each other and usually interact through a communications network. A relationship between the client and the server is generated by computer programs running on respective computers and having a client-server relationship with each other. The server may be a cloud server, a server in a distributed system, or a server combined with a blockchain.

It should be understood that steps may be reordered, added, or deleted using the various forms of procedures shown above. For example, the steps recorded in the present disclosure may be performed in parallel, in order, or in a different order, provided that the desired result of the technical solutions disclosed in the present disclosure can be achieved, which is not limited herein.

Although the embodiments or examples of the present disclosure have been described with reference to the accompanying drawings, it should be appreciated that the method, system, and device described above are merely example embodiments or examples, and the scope of the present disclosure is not limited by the embodiments or examples, but defined only by the granted claims and the equivalent scope thereof. Various elements in the embodiments or examples may be omitted or substituted by equivalent elements thereof. Moreover, the steps may be performed in an order different from that described in the present disclosure. Further, various elements in the embodiments or examples may be combined in various ways. It is important that, as the technology evolves, many elements described herein may be replaced with equivalent elements that appear after the present disclosure.

What is claimed is:

1. A display device, comprising:
a device body, wherein a display screen and a first input control are disposed on the device body; and
a controller electrically connected to the first input control and the display screen,
wherein the controller is configured to: based on receiving a first information request instruction input through the first input control and determining that the display device has been associated with a first preset application, obtain first information to be displayed for the first information request instruction, and control the display screen to display the first information to be displayed, wherein the first information request instruction is input through the first preset application.

2. The display device according to claim 1,
wherein a camera and a second input control are disposed on the device body; and
wherein the controller is electrically connected to the camera and the second input control, and is further configured to: based on receiving a code scanning instruction input through the second input control and determining that the display device has been associated with the first preset application, control the camera to be turned on to scan a target two-dimensional bar code, such that an associated device corresponding to the target two-dimensional bar code obtains related information to the display device through the target two-dimensional bar code.

3. The display device according to claim 2, wherein the controller is further configured to:
based on receiving the code scanning instruction input through the second input control and determining that the display device has been associated with the first preset application, obtain the first information to be displayed, and control the display screen to display the first information to be displayed.

4. The display device according to claim 1,
wherein a third input control is disposed on the device body; and
wherein the controller is electrically connected to the third input control, and the controller is further configured to: based on receiving a second information request instruction input through the third input control and determining that the display device has been associated with a second preset application, obtain second information to be displayed for the second information request instruction, and control the display screen to display the second information to be displayed, wherein the second information request instruction is input through the second preset application.

5. The display device according to claim 4, wherein the first input control and the third input control are the same control, and the first information request instruction and the second information request instruction are respectively input by an operation on the first input control.

6. The display device according to claim 1, wherein the display device includes a camera, and the controller is configured to associate the display device with the first preset application through the following steps:
controlling, in response to determining that the display device has not been associated with the first preset application, the display screen to display a login interface of the first preset application;
controlling, in response to determining that the first preset application has been logged in through the login interface, the camera to be turned on to capture a face image;
sending the face image to a server;
receiving an authentication result for the face image from the server; and
associating, based on determining that the authentication result indicates that authentication is passed, the display device with the first preset application.

7. The display device according to claim 1, wherein the display device includes a camera, and the controller is configured to associate the display device with the first preset application through the following steps:
controlling the camera to be turned on to scan a first two-dimensional bar code corresponding to the first preset application logged in on another terminal device, such that the display device is associated with the first preset application through the first two-dimensional bar code.

8. The display device according to claim 1, wherein the display device includes a camera, and the controller is configured to associate the display device with the first preset application through the following steps:
controlling the display screen to display a second two-dimensional bar code corresponding to the display device, such that the association of the display device with the first preset application is implemented by scanning the second two-dimensional bar code through the first preset application logged in on another terminal device.

9. The display device according to claim 1,
wherein a fourth input control and a near field communications device are disposed on the device body; and
wherein the controller is electrically connected to the fourth input control and the near field communications device, and the controller is further configured to: based on receiving a connection instruction input through the fourth input control, obtain data of a smart device in contact with the display device through the near field communications device, such that the display device is associated with the smart device.

10. The display device according to claim 9, wherein the smart device includes at least one of a traffic card or an entrance guard card.

11. The display device according to claim 1,
wherein a positioning device is disposed on the device body and is configured to obtain position information of the display device; and
wherein the controller is electrically connected to the positioning device, and the controller is further configured to send the position information obtained by the positioning device to a server.

12. The display device according to claim 1, wherein the device body has a card-shaped structure.

13. The display device according to claim 1, wherein the first information to be displayed is a health code.

14. The display device according to claim 4, wherein the second information to be displayed is a travel card.
